(19) United States
(12) Patent Application Publication
(10) Pub. No.: US 2015/0352585 A1
(43) Pub. Date: Dec. 10, 2015

(54) SPRAY BOOTH HUMIDITY CONTROL

(71) Applicants: AXALTA COATING SYSTEMS IP CO., LLC, Wilmington, DE (US); COATINGS FOREIGN IP CO., Wilmington, DE (US)

(72) Inventors: John Charles LARSON, West Chester, PA (US); Joel SMITH, Wilmington, DE (US)

(73) Assignee: AXALTA COATING SYSTEMS IP CO., LLC, Wilmington, DE (US)

(21) Appl. No.: 14/438,648

(22) PCT Filed: Oct. 28, 2013
(86) PCT No.: PCT/US2013/067044

§ 371 Date: Apr. 27, 2015

Related U.S. Application Data
(60) Provisional application No. 61/719,465, filed on Oct. 28, 2012.

(51) Int. Cl. B05B 15/12

(52) U.S. Cl. CPC B05B 15/1222

(57) ABSTRACT

The present disclosure is directed to a system for applying a waterborne coating composition to form a coating layer. The disclosure is particularly directed a system having dual water spraying devices for automatically introducing water into incoming air to produce a spray booth having a target range of humidity level. The system of this disclosure is particularly useful for applying a waterborne coating composition having effect pigments in a low humidity and high temperature climate.

### CROSS REFERENCE TO RELATED APPLICATION

This application is a U.S. National-Stage entry under 35 U.S.C. §371 based on International Application No. PCT/US2013/067044, filed Oct. 28, 2013, which was published under PCT Article 21(2) and which claims priority to U.S. Patent Application No. 61/719,465, filed Oct. 28, 2012, all of which are incorporated herein by reference in their entirety.

### FIELD OF DISCLOSURE

The present disclosure is directed to a system for applying a waterborne coating composition over a substrate to form a coating layer. The present disclosure is particularly directed to a system having an automatic humidity control for applying a waterborne coating composition over a substrate to form a coating layer.

### BACKGROUND OF DISCLOSURE

Volatile organic compounds (VOCs) are commonly used in industrial products or processes, such as solvents, dispersants, carriers, coating compositions, molding compositions, cleaners, or aerosols. Volatile organic compounds (VOCs) are compounds of carbon, which can emit into atmosphere and participate in atmospheric photochemical reactions. VOCs emitted into the atmosphere, such as those emitted from coating compositions during coating manufacturing, application and curing processes, can be related to air pollution impacting air quality, participate in photoreactions with air to form ozone, and contribute to urban smog and global warming.

Efforts have been made to reduce VOC emissions into the air. Waterborne coating compositions contain less or are essentially free from VOCs and are used more and more in coatings due to their reduced environmental impacts.

Since waterborne coating compositions contain significant amounts of water, atmospheric humidity can affect the drying of wet coating layers. Accordingly, there is a need for controlling humidity when a waterborne coating composition is applied to form a coating layer.

### SUMMARY

This disclosure is directed to a system (1) for applying a waterborne coating composition over a substrate to form a coating layer, the system comprising:

(A) a spray booth (2) for spraying the waterborne coating composition over the substrate (3), wherein the spray booth comprises one or more air inlets (4) for introducing an incoming air (5) or conditioned incoming air (5′) into the spray booth; and

(B) a water introduction device (6) for introducing water into the incoming air, wherein the water introduction device comprises a first set of water spraying devices (8) coupled to a first water supply device (9), a second set of water spraying devices (10) coupled to a second water supply device (11), a water supply controlling device (12) that controls water supply from the second water supply device to the second set of water spraying devices, and a water pump (13) coupled to the first water supply device and the second water supply device;

wherein, the water introduction device, when in operation, is configured to introduce water into the incoming air to produce the conditioned incoming air when a humidity level of air within the spray booth is below a target range of humidity level of the spray booth;

with the proviso that the water introduction device is configured to have the water supply controlling device (12) in a closed state so water is only introduced from the first set of water spraying devices into the incoming air when the humidity level of air within the spray booth is below the target range of humidity level, but above a preset first humidity level, and the water introduction device is configured to have the water supply controlling device (12) in an open state so water is introduced from both the first and the second sets of water spraying devices into the incoming air when the humidity level of air within the spray booth is below the preset first humidity level.

This disclosure is also directed to a substrate coated with the coating layer produced in the system disclosed herein from the waterborne coating composition, wherein the coating layer is essentially free from edge flashing or coarse dry.

### BRIEF DESCRIPTION OF DRAWINGS

FIG. 1 shows schematic representations of examples of the system wherein:

FIG. 1A is an example of the system having the water supply controlling device coupled to the humidity measuring device; and

FIG. 1B is an example of the system having a computing device.

FIG. 2 shows schematic representations of examples of the water introduction device wherein:

FIG. 2A is a water introduction device having water supply devices installed inside an air duct device and having the water pump on with the water supply controlling device turned off;

FIG. 2B is a water introduction device having the water pump on with the water supply controlling device turned on;

FIG. 2C is a water introduction device having water supply devices installed outside an air duct device and the water spraying device inside the air duct device; and

FIG. 2D is a top-down view of the water introduction device.

FIG. 3 shows further schematic representations of examples of the water introduction device wherein:

FIG. 3A is a water introduction device having the water pump on with the water supply controlling device turned off;

FIG. 3B is a water introduction device having the water supply controlling device turned on; and

FIG. 3C is a water introduction device having the subsequent water supply controlling device turned on.

FIG. 4 is a graph showing a representation of examples of the system in various operation settings.

### DETAILED DESCRIPTION

The following detailed description is merely exemplary in nature and is not intended to limit the various embodiments or the application and uses thereof. Furthermore, there is no intention to be bound by any theory presented in the preceding background or the following detailed description

As used herein:

The term “effect pigment” or “effect pigments” refers to pigments that produce special effects in a coating. Examples of effect pigments can include, but are not limited to, light absorbing pigment, light scattering pigments, light interference pigments, and light reflecting pigments. Metallic flakes, for example aluminum flakes, can be examples of such effect pigments.

The term “gonioapparent flakes”, “gonioapparent pigment” or “gonioapparent pigments” refers to pigment or pigments pertaining to change in color, appearance, or a combination thereof with change in illumination angle or viewing angle. Metallic flakes, such as aluminum flakes are examples of gonioapparent pigments. Interference pigments or pearlescent pigments can be further examples of gonioapparent pigments.

“Appearance” used herein refers to (1) the aspect of visual experience by which a coating is viewed or recognized; and (2) perception in which the spectral and geometric aspects of a coating is integrated with its illuminating and viewing environment. In general, appearance includes texture, sparkle, glitter, or other visual effects of a coating. Appearance usually varies with varying viewing angles or varying illumination angles.

The term “vehicle”, “automotive”, “automobile”, “automotive vehicle”, or “automobile vehicle” refers to an automobile such as car, van, minivan, bus, SUV (sports utility vehicle); truck; semi-truck; tractor; motorcycle; trailer; ATV (all-terrain vehicle); pickup truck; heavy duty mover, such as, bulldozer, mobile crane and earth mover; airplanes; boats; ships; and other modes of transport that are coated with coating compositions.

The term “spray booth” refers to a device or a space where spray coating applications can be conducted. Typically, a spray booth can comprise a space that can be enclosed. The spray booth can also comprise one or more air inlets for incoming air to enter the space and one or more air outlets for exhaust air to exit the space. A substrate, such as a vehicle or a vehicle part, can be positioned in the spray booth for applying one or more coating layers thereon. The incoming air can be filtered or otherwise cleaned to remove particles or other solid or non-solid contaminants.

A computing device used herein can refer to a data processing chip, a desktop computer, a laptop computer, a pocket PC, a personal digital assistant (PDA), a handheld electronic processing device, a smart phone that combines the functionality of a PDA and a mobile phone, or any other electronic devices that can process information automatically. A computing device can be built into other electronic devices, such as a built-in data processing chip integrated into an imaging device, color measuring device, or an appearance measuring device. A computing device can have one or more wired or wireless connections to a database, to another computing device, or a combination thereof. A computing device can be a client computer that communicates with a host computer in a multi-computer client-host system connected via a wired or wireless network including intranet and internet. A computing device can also be configured to be coupled with a data input or output device via wired or wireless connections. For example, a laptop computer can be operatively configured to receive color data and images through a wireless connection. A “portable computing device” includes a laptop computer, a pocket PC, a personal digital assistant (PDA), a handheld electronic processing device, a mobile phone, a smart phone that combines the functionality of a PDA and a mobile phone, a tablet computer, or any other electronic devices that can process information and data and can be carried by a person.

This disclosure is directed to a system (1) for applying a waterborne coating composition over a substrate to form a coating layer. The system can comprise:

(A) a spray booth (2) for spraying the waterborne coating composition over the substrate (3). The spray booth comprises one or more air inlets (4) for introducing an incoming air (5) or conditioned incoming air (5′) into the spray booth; and

(B) a water introduction device (6) for introducing water into the incoming air, wherein the water introduction device comprises a first set of water spraying devices (8) coupled to a first water supply device (9), a second set of water spraying devices (10) coupled to a second water supply device (11), a water supply controlling device (12) that controls water supply from the second water supply device to the second set of water spraying devices, and a water pump (13) coupled to the first water supply device and the second water supply device;

(C) one or more first humidity measuring devices (18) for measuring a humidity level of air within the spray booth;

wherein, the water introduction device, when in operation, is configured to introduce water into the incoming air to produce the conditioned incoming air when the humidity level of air within the spray booth is below a target range of humidity level of the spray booth;

with the proviso that the water introduction device is configured to have the water supply controlling device (12) in a closed state so water is only introduced from the first set of water spraying devices into the incoming air when the humidity level of air within the spray booth is below the target range of the humidity level, but above a preset first humidity level, and the water introduction device is configured to have the water supply controlling device (12) in an open state so water is introduced from both the first and the second sets of water spraying devices into the incoming air when the humidity level of air within the spray booth is below the preset first humidity level.

The system can be configured automatically or manually. In one example, an operator can manually operate the water supply controlling device (12) to be in a closed state when the humidity level of air within the spray booth is below the target range of the humidity level, but above a preset first humidity level, and manually operate the water supply controlling device (12) to be in an open state when the humidity level of air within the spray booth is below the preset first humidity level.

The system can further comprises one or more first thermal measurement devices (17) for measuring a temperature of air within the spray booth, one or more second thermal measurement devices (17′) for measuring the temperature of the incoming air, and one or more second humidity measuring devices (18′) for measuring the humidity level of the incoming air.

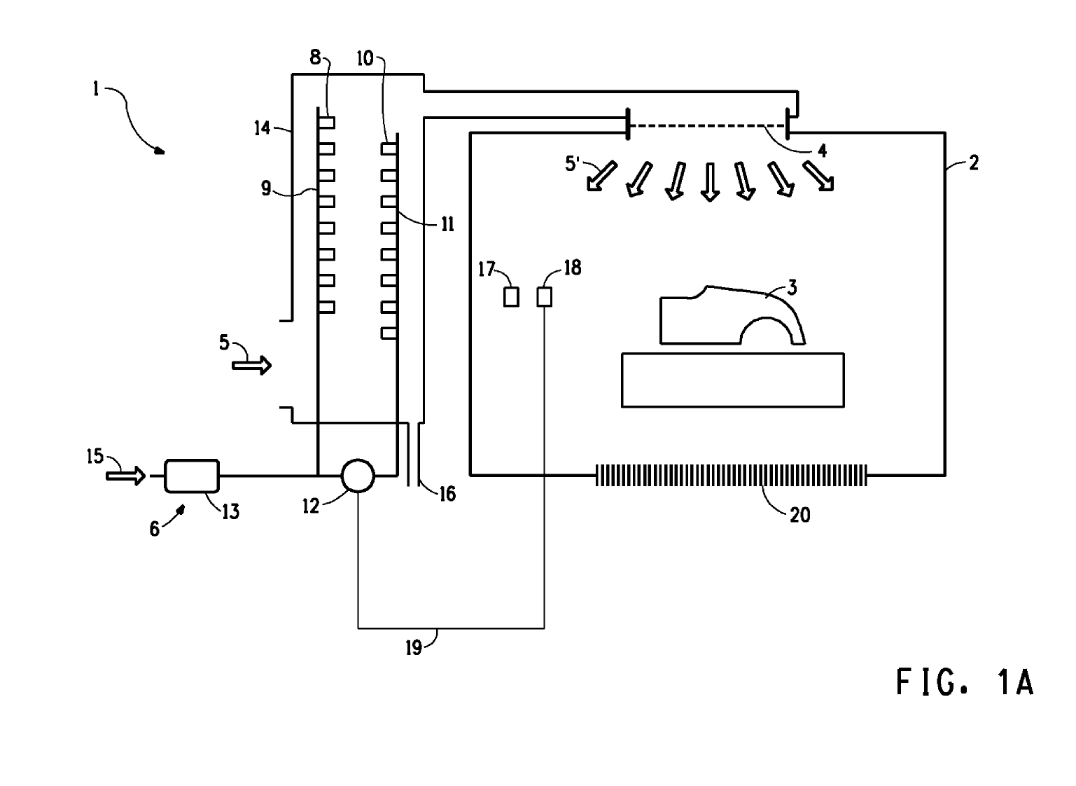

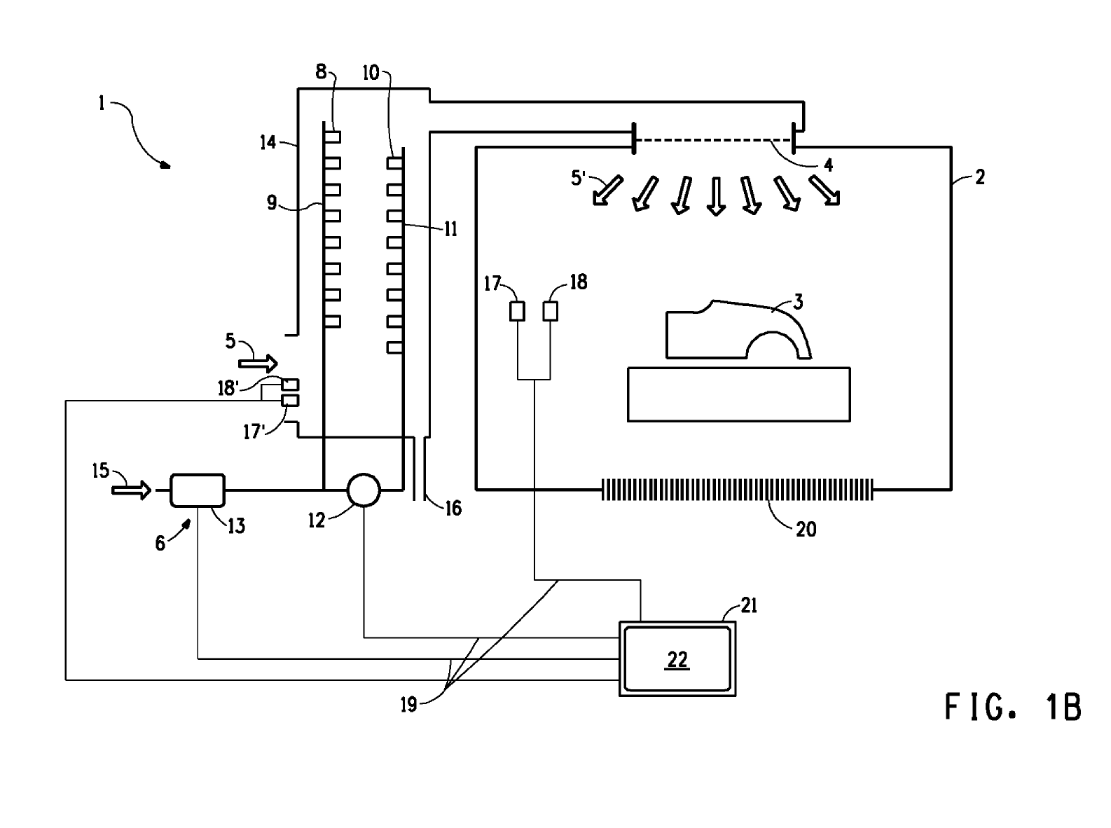

The system can be configured to operate automatically, wherein the water pump (13) and the water supply controlling device (12) each is coupled with the one or more first humidity measuring devices (18) to receive an actual humidity level of air within the spray booth (FIG. 1A), wherein, when in operation:

the water pump (13) is configured to automatically provide water to the first and the second water supply devices when the actual humidity level of air within the spray booth is below the target range of humidity level,

the water supply controlling device is configured to automatically be in the closed state turning off water supply to the second set of water spraying devices when the actual humidity level of air within the spray booth is below the target range of the humidity level, but above the preset first humidity level, and

the water supply controlling device is configured to automatically be in the open state to supply water to the second set of water spraying devices via the second water supply device when the actual humidity level of air within the spray booth is below the preset first humidity level.

The system can comprise one or more water drains (16) (FIGS. 1A and 1B) for draining water, such as condensation water, from the air duct device (14) if needed. The water drains (16) can be plugged when not in use.

The water pump and the water supply control device can be controlled automatically based on the humidity level of air within the spray booth that is obtained from the one or more first humidity measuring devices (18). The water pump and the water supply control device and the one or more first humidity measuring devices can be coupled via wired or wireless connections.

Wired connections can include hardware couplings, splitters, connectors, cables or wires. Wireless connections can include, but not limited to, Wi-Fi device, Bluetooth device, wide area network (WAN) wireless device, local area network (LAN) device, broadband devices such as 3G or 4G, infrared communication device, optical data transfer device, radio transmitter and optionally receiver, wireless phone, wireless phone adaptor card, or any other devices that can transmit signals in a wide range of radio frequency including visible or invisible optical wavelengths and electromagnetic wavelengths.

Commercially available humidity responsive controls, such as humidity control system available as CP-TSS Controller Package (which includes a 300 F relative humidity sensor) from Precision for Collision, Roseville, Calif. 95678, can be suitable for controlling the water pump and the water supply control device. Commercially available water pumps such as BMINDP2 from Precision for Collision can also suitable. The water supply control device can be a valve device such as a solenoid control valve. Solenoid control valves, such as Danfoss VDHT solenoid valves available from Danfoss North America, Md. 21009, USA, can be suitable.

In another exemplary embodiment, the system further comprises a computing device (21) functionally coupled to the first humidity measuring devices (18), the water supply controlling device (12), the water pump (13), optionally, the first thermal measurement devices (17), one or more second thermal measurement devices (17′), and one or more second humidity measuring devices (18′) (FIG. 1B);

wherein the computing device can be configured to comprise a first set point when the humidity level of air within the spray booth is below the target range of the humidity level, but above the preset first humidity level, and a second set point when the humidity level of air within the spray booth is below the preset first humidity level; and

at the first set point, when in operation, the computing device automatically causes the water supply controlling device being in the closed state and causes the water pump to supply water only to the first set of water spraying devices via the first water supply device; and

at the second set point, when in operation, the computing device automatically causes the water supply controlling device being in the open state and causes the water pump to supply water to both the first and second set of water spraying devices via the first and second water supply devices.

The first set point and the second set point can be programmed in a computer program that is installed on or accessible from the computing device. In one example, the computer program can be installed on the computing device. In another example, the computer program can be installed on a separate computing device that can be access from the computing device via wired or wireless connections, such as a host-client computing network system or an internet system. In yet another example, the computing program can be installed on both client and host computers.

The computing device can be functionally coupled to the devices via wired or wireless connections (19). Any of the aforementioned wired or wireless connections can be suitable. The computing device can be further coupled to one or more data input or data output devices via wired or wireless connections.

The computing device can comprise a display device (22) (FIG. 1B) to display the target range of the humidity level, the preset first humidity level, and/or the actual humidity level of air within the spray booth that is obtained from the one or more first humidity measuring devices. When available, the temperature of air within the spray booth obtained from the first thermal measurement devices, the temperature of the incoming air obtained from the one or more second thermal measurement devices, and/or the humidity level of the incoming air obtained from the one or more second humidity measuring devices can also be displayed on the display device. The closed state or the open state of the water supply controlling device, operation of the water pump, or a combination thereof, can also be displayed on the display device.

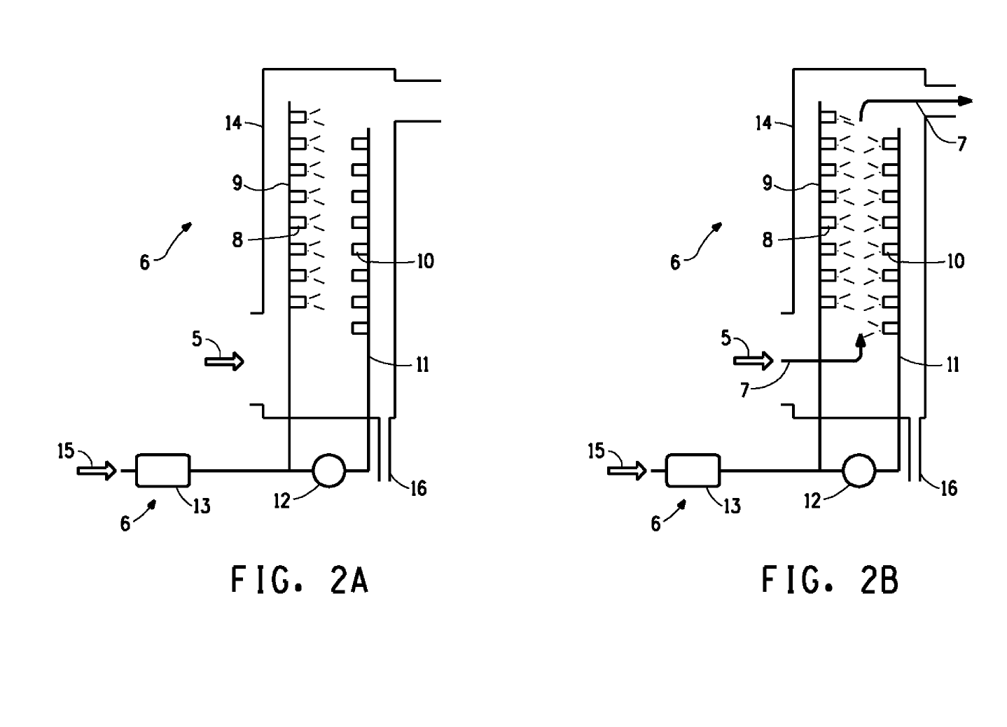

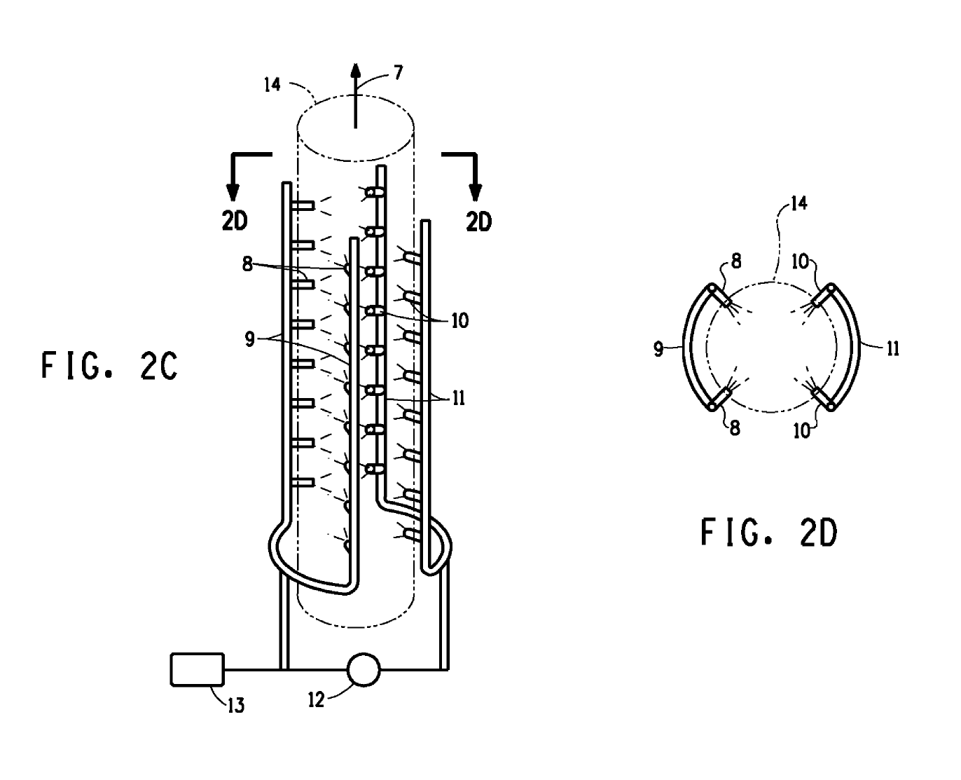

When in operation, the system can spray water into the incoming air with only the first set of water spraying devices (FIG. 2A) when the humidity level of air within the spray booth is below the target range of the humidity level, but above a preset first humidity level. The system can spray water into the incoming air with both the first set and the second set of water spraying devices (FIG. 2B) when the humidity level of air within the spray booth is below the preset first humidity level.

The first set of water spraying devices (8) and the second set of water spraying devices (10) can be housed in an air duct device (14) coupled to the one or more air inlets (4). The first and/or the second water supply devices (9 and 11) can be installed inside (FIG. 2A-2B) or outside (FIG. 2C-2D) of the air duct device (14). When the one or both of the water supply devices are installed outside the air duct device, the water spraying devices can be installed through the side of the air duct device as schematically illustrated in FIG. 2D.

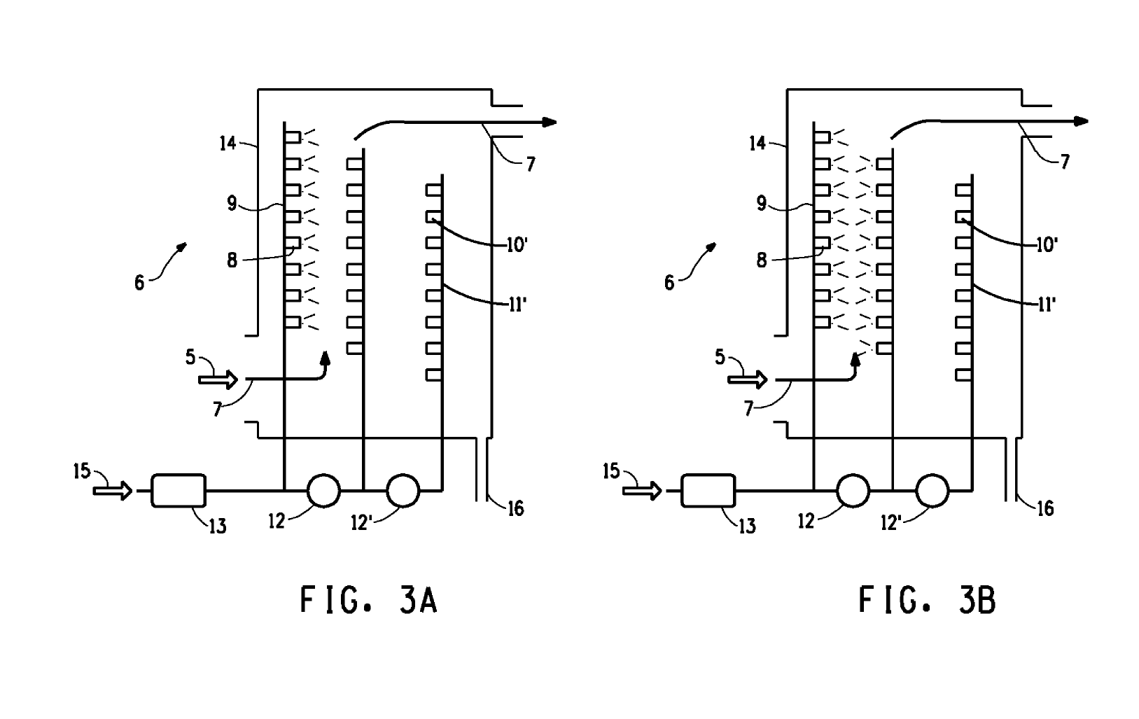

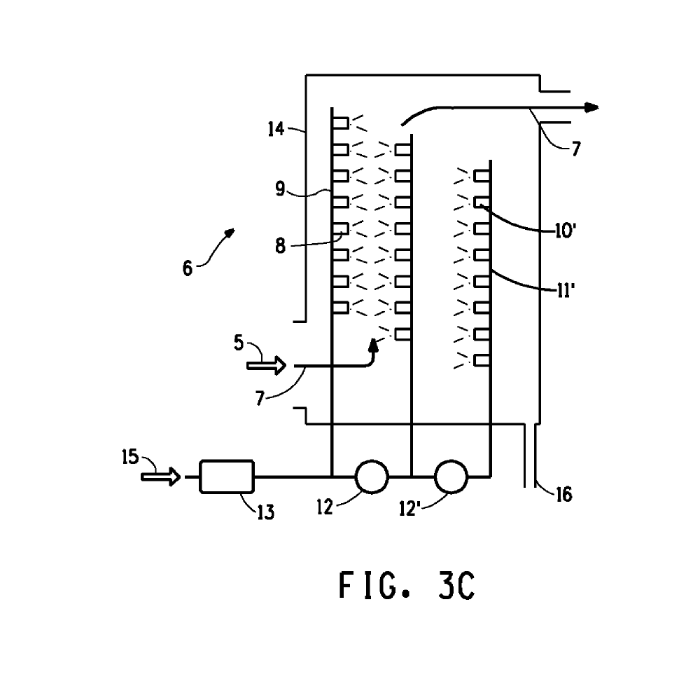

The system can further comprise one or more subsequent sets of water spraying devices (10′) coupled to one or more individual subsequent water supply devices (11′) that each is coupled to a subsequent individual water supply controlling device (12′) and the water pump (13) (FIG. 3A-3C). Each of the subsequent set of water spraying devices can be coupled to an individual subsequent water supply device (11′) and a subsequent individual water supply controlling device (12′). It is preferred that the subsequent set of water spraying devices is coupled to the water pump so no additional pump is needed. The system can be configured to have the water supply controlling device and the subsequent water supply controlling device(s) to be in a closed state turning off water supply to the second and the subsequent water spraying devices (FIG. 3A). The system can be configured to have the water supply controlling device to be in an open state providing water to the second water spraying devices and the subsequent water supply controlling device(s) to be in a closed state turning off water supply to the subsequent water spraying devices (FIG. 3B). The system can be configured to have both water supply controlling devices to be in an open state providing water to the second and subsequent water spraying devices (FIG. 3C).

In an embodiment, the system has a subsequent preset humidity level. In one example, the system can have a second preset humidity level that is below the aforementioned preset first humidity level. When in operation, the system can be configured to spray water into the incoming air with the first set, the second set and the subsequent set of water spraying devices when the humidity of the air in the spray booth is below the subsequent preset humidity level (FIG. 3C).

The first and the second water supply devices can be pipes, hoses, channels, tubes, or a combination thereof, and can be made from flexible materials such as plastics or polymers, metal such as copper, steel, iron, aluminum, or any other metals or alloys thereof that are suitable for supplying water, or a combination thereof.

Any high pressure water pump can be suitable. Water pumps that have a maximum pressure rating in a range of from about 35.15 to about 105.5 kgfcm² (kilograms/square centimeter) (about 500 to about 1500 psi (pounds per square inch)) and a maximum water introduction rate in a range of from about 3.78 liters (l) to about 5.68 l per minute (about 1.0 to about 1.5 gallon per minute) can be preferred.

The water supply control device can be an inline valve, switch, or other electrical, mechanical, hydraulic, or magnetic controllable device that can be turned on or off to control water supply.

The number of the first set of water spraying devices and the number of the second set of water spraying device can be determined based on parameters comprising individual water spray rates of the water spraying devices, temperature and humidity level of the incoming air, target ranges of humidity levels of the spray booth, and air flow rates of the incoming air, as described below. Other parameters or conditions can also apply.

In an embodiment, the parameters further comprise a history of temperatures and humidity levels of the incoming air that can be obtained from a data provider, such as local or national weather services, an online weather condition posting provided by individuals or organizations, or a combination thereof. The number of the first set of water spraying devices, the number of the second set of water spraying device, and the number of any subsequent set of water spraying device when present can be determined based on the history of temperatures and humidity levels of the incoming air. In one example, the highest temperature and lowest humidity level of the geographic location in last 10-15 years where the spray booth is located or to be located can be used to determine the number of water spraying nozzles needed for the spray booth.

The system can be suitable for locations with high temperature and low humidity levels. The system can also be suitable for locations that have very low external temperatures, such as below water freezing temperature, and require heating the incoming air for the spray booth. As disclosed herein, the incoming air can be ambient air from the atmosphere external to the spray booth, conditioned air that has been modified such as heated or cooled, or a combination thereof.

The temperature level of the incoming air can be in a range of from about 26° C. (about 80° F.) to about 49° C. (about 120° F.) and the humidity level of the incoming air can be in a range of from about 1% relative humidity (RH) to about 25% RH, and wherein the spray booth, when in operation, can have an actual air temperature and an actual humidity level of air within the spray booth in a range of from about 15° C. (about 60° F.) to about 38° C. (about 100° F.) and in a range of from about 30% RH to about 60% RH, respectively.

The incoming air, when in operation, can be flowing into the spray booth at an air flow rate that is essentially constant. This can be important for the operation of the spray booth since there is a need for constant air flow to remove excess paint in the air of the spray booth, to remove moisture or solvents if any discharged from the coating composition being sprayed, and for proper drying of the coating layers.

This disclosure is also directed to a substrate coated with the coating layer produced in the system from the waterborne coating composition, wherein the coating layer is essentially free from edge flashing or coarse dry, as described below.

The waterborne coating composition can comprise one or more metallic effect pigments, wherein the substrate can have one or more existing coating layers having an existing visual coating effect produced from one or more existing metallic effect pigments, and the coating layer produced thereof having a visual effect matching an existing visual effect.

The substrate can be a vehicle, vehicle body, or a vehicle part.

A process for applying a waterborne coating composition over a substrate to form a coating layer can comprise the steps of:

a) obtaining temperature and humidity level of an incoming air for a spray booth;

b) determining a water introduction rate based on the temperature and humidity level of the incoming air, an air flow rate of the incoming air, and a target range of humidity level of the spray booth;

c) producing a conditioned incoming air by introducing water into the incoming air at the air flow rate and at the water introduction rate; and

d) providing the conditioned incoming air to the spray booth to produce a conditioned spray booth.

The process can further comprise the step of:

e) applying the waterborne coating composition over the substrate in the conditioned spray booth to produce the coating layer.

The waterborne coating composition can be applied in the conditioned spray booth to produce a wet coating layer. The process can further comprise the step of drying or curing the wet coating layer to produce the coating layer. The drying or curing process can be done in the conditioned spray booth. The drying or curing process can also be done without the conditioned incoming air. The waterborne coating composition can be sprayed over the substrate in the conditioned spray booth with the conditioned incoming air, and the resulting coating layer can be dried when the spray booth is supplied with the incoming air without the water being introduced into the incoming air. This can be advantageous by providing required humidity when the coating composition is sprayed to produce a coating having desired coating appearance, and then provide the incoming air with less humidity after the coating has been sprayed to accelerate drying of the coating layer.

The incoming air can be direct ambient air from the atmosphere external to the spray booth, recycled air that has been used, conditioned air that has been modified, or a combination thereof. For example, a portion of the air that has exited a spray booth can be recycled back to the spray booth. The recycle air can be cleaned or filtered. In another example, the incoming air can first be conditioned to reduce its temperature with an air conditioning device, or to increase its temperature by a heating device.

Temperature of the incoming air can be dry bulb temperature and can be obtained from direct thermometer measurement, current local weather station temperature posting or broadcasting, weather station temperature forecast for a specific time frame, online weather condition posting, or a combination thereof. The direct thermometer measurement can be done by using a thermal measurement device, such as a thermometer, for example, a mercury thermometer, a liquid thermometer, a digital thermometer, or a combination thereof.

The humidity level of the incoming air or the spray booth can be measured using a humidity measuring device, such as a hygrometer or psychrometer. The humidity level of the incoming air can also be obtained from a current local weather station posting on relative humidity or dew point, a weather station forecast on relative humidity or dew point for a specific time frame, an online weather condition posting, or a combination thereof.

The air flow rate of the incoming air can be measured or calculated based on dimensions and velocity of the air flow, obtained by using the spray booth manufacturer's design parameter for air flow rate through the spray booth, measuring the actual air flow rate using air flow measurement instruments, or a combination thereof. The air flow rate of the incoming air can be volumetric air flow rate, such as cubic meters (or cubic feet) per minute, or mass air flow rate, such as kilograms (or pounds) per minute, and can be converted to one or another.

In an embodiment, the water introduction rate is determined by a water rate process comprising the steps of:

b1) determining specific humidity of the incoming air based on the temperature and humidity level of the incoming air;

b2) determining a target specific humidity based on a target range of the humidity level of the spray booth;

b3) producing a specific humidity difference based on the specific humidity of the incoming air and the target specific humidity; and

b4) determining the water introduction rate based on the air flow rate of the incoming air and the specific humidity difference.

The water rate process can further comprise the steps of:

b5) repeating the steps b1)-b4) to determine one or more subsequent water introduction rates based on one or more subsequent temperatures and a subsequent humidity levels of the incoming air, one or more subsequent target ranges of the humidity levels, and one or more subsequent air flow rates of the incoming air; and

b6) producing a humidity correlation function correlating water introduction rates with the temperatures and humidity levels of the incoming air, target ranges of the humidity levels, and air flow rates of the incoming air.

The temperature and humidity level of the incoming air can be obtained as described above. Specific humidity of the incoming air (Hₛₚ₋ᵢₙ) can be derived from the temperature and relative humidity or dew point of the incoming air. The specific humidity can be the kilograms (pounds) of water vapor per kilogram (pound) of dry air. It can be expressed as “grains” of water vapor per kilogram (pound) of dry air, where 7000 grains=0.45 kg (1 pound). For example, the specific humidity of the incoming air can be determined by using a psychrometric chart, wheel calculators, computer software having psychrometric functions, or a combination thereof. The specific humidity of the incoming air can also be determined by using formulas in the ASHRAE (American Society of Heating, Refrigerating and Air-Conditioning Engineers) Handbook. The specific humidity for the spray booth at the target range of humidity level can also be determined using the similarly process. Typically, a minimum specific humidity that is required for successful application of a waterborne coating can be referred to as a target specific humidity (H_{sp-target}) and can be expressed as water vapor per kilograms (or pounds) of dry air (grains/kg) or (grains/lb). In one example, the target specific humidity can be about 132 grains/kg (about 60 grains/lb).

The specific humidity difference between the incoming air and the target specific humidity can be determined by the following formula:

ΔHₛₚ=H_{sp-target}−Hₛₚ₋ᵢₙ (Formula 1).

For example, for an incoming air at about 37.78° C. (about 100° F.) and 10% RH, the specific humidity is about 66 grains/kg (30 grains/lb) according to a psychrometric chart. With the target specific humidity being 132 grains/kg (60 grains/lb), the difference ΔHₛₚ can be calculated at about 66 grains/kg (30 grains/lb). The ΔHₛₚ reflects the amount of water that needs to be introduced into the incoming air based on per kilogram (or pound) of air.

The air flow rate of the incoming air can be obtained by using the spray booth manufacturer's design parameter for air flow rate through the spray booth, measuring the actual air flow rate using air flow measurement instruments, or a combination thereof. Examples of air flow measurement instruments can include, for example, Pitot Tubes available from Dwyer Instruments, Inc., Michigan City, Ind., USA, an anemometer, or a velometer.

The volumetric air flow rate (Fᵥ) can be converted to mass air flow rate (F_{w}). The common molecular weight of air is 29 grams/gram-mole (or pound per mole, or lb-mole), i.e., there are 29 grams of air per gram-mole of air. Assume the ideal gas law applies: one gram mole of air occupies 22.39 cubic meters. The mass air flow rate of the air in kilograms per minute (kg/min) can be calculated by the formula:

F_{w}=(Fᵥ)/359×29 (Formula 2).

For example: If the volumetric air flow rate is 15,000 CFM (cubic feet per minute) then the mass air flow rate is approximately 1212 pounds per minute (lb/m): 15,000/359×29=1212.

The water introduction rate in gallons per hour (W_{gal/hr}) can be calculated by: first multiply the mass air flow rate by the specific humidity difference to yield the amount of water needed in grains, and then convert the grains into pounds per hour, and further convert into gal/hr. The following formulas can be used:

Water rate(grain/minute)W_{grain/min}=F_{w}×ΔHₛₚ (Formula 3)

Water rate(pounds/hour)W_{lbs/hr}=(W_{grain/min})/7000×60 (Formula 4)

Water rate(gallon/hour)W_{gal/hr}=(W_{lbs/hr})/8.33 (Formula 5).

For example, 30 grains per pound of specific humidity difference can be calculated into 1212×30=36,350 grains per minute (W_{grain/min}). Then W_{grain/min} can be divided by 7000 to get the pounds of water needed to be added: 36,500/7000=5.2 pounds per minute, and times 60=312 pounds per hour (W_{lbs/hr}). Further, the W_{lbs/hr} can be divided by 8.33 to produce the water introduction rate of 37.4 gallons per hour.

When the humidity correlation function is established as described above, the water introduction rate can also be determined based on the temperature and humidity level of the incoming air, an air flow rate of the incoming air, a target range of humidity level of the spray booth, and the humidity correlation function. The humidity correlation function can be displayed on a piece or a set of paper, a digital display device such as a monitor, a PDA, a smart phone, a wheel calculator, or any other display devices. The humidity correlation function can correlate individual water introduction rates with temperatures and humidity levels of the incoming air, target ranges of the humidity levels of the spray booth, and air flow rates of the incoming air.

The humidity correlation function can also be established by calculation, experimental measurements, or a combination thereof. In one example, the humidity correlation function can be established by setting different variables, such as varying water introduction rates, air flow rates of the incoming air, and temperatures and humidity levels of the incoming air, and measuring the resulting humidity levels in the spray booth. In another example, the humidity correlation function can be established by calculations based on the variables and space volume of the spray booth. In yet another example, the humidity correlation function can be established by a combination of measurements and calculations. In yet another example, psychometric functions integrated into an Excel spreadsheet can be used to provide the humidity correlation function.

In step c), the water can be introduced into the incoming air using one or more water introduction devices described herein.

The amount of evaporated water can be expressed with the empirical equation:

g=ΘA(xₛ−x) (Formula 6)

wherein:

g=amount of evaporated water (lb/h);

Θ=(25+19v), evaporation coefficient (lb/ft²h);

v=velocity of air at the water surface (ft/s);

A=water surface area (ft²);

xₛ=humidity ratio in saturated air at the same temperature as the water surface (grains/lb) (grains H₂O in lb Dry Air); and

x=humidity ratio in the air (grains/lb) (grains H₂O in lb Dry Air).

The Formula 6 shows that the variables affecting the evaporation of water can include: velocity of the air (also referred to as air flow rate of the incoming air), the surface area of the water, and the driving force for evaporation (difference between the humidity ratio of the saturated air and the humidity ratio of the incoming air). The driving force for evaporation can be in a range of from about 44 grains/kg to about 132 grains/kg (about 20 to about 60 grains/lb). The driving force for evaporation can be in a range of from about 44 grains/kg to about 132 grains/kg (about 20 to about 60 grains/lb) in one example, in a range of from about 44 grains/kg to about 110 grains/kg (about 20 to about 50 grains/lb) in another example, and in a range of from about 66 grains/kg to about 110 grains/kg (about 30 to about 50 grains/lb) in yet another example.

The target range of humidity level of the spray booth can also include the aforementioned target range of specific humidity or the driving force for evaporation.

The water surface area (A) can be affected by the methods or apparatuses for introducing water into the incoming air stream. Examples of methods or apparatus can include, but not limited to, atomizing water into the incoming air; distributing water across one or more beds, pads, or membrane of media that the incoming air can flow through; one or more water curtains through the incoming air flow; one or more open water troughs where the incoming air can flow over; or a combination thereof.

Water can be atomized into atomized droplets producing large water surface area. Typically, the smaller the droplets size, the greater the water surface area. Examples of methods for atomizing water can include: steam, high pressure (airless) atomization, ultrasonic atomization, compressed gas atomization, spraying, combinations of ultrasonic and compressed gas, or a combination thereof. One or more atomizers can be used. One or more spraying devices can be used. In one example, the spraying device can comprise one or more nozzles. The spraying devices can be located in air ducts, air plenums, or supply inlet filter boxes of the spray booth, or a combination thereof. The amount of water evaporated can be controlled by the number of atomizers or spraying devices operating, the water/steam flow rate, or a combination thereof.

For distributing water across a bed, pad, or membrane of media, one or more porous media that can have large surface area can be used. Examples of such porous media can include nanofiber membranes. The media can be hydrophilic and should not create significant pressure drop on the incoming air stream when it passes through. The media can be oriented parallel or perpendicular or at an angle in between, to the flow of the incoming air. The amount of water evaporated can be controlled with the pumping rate of water to the media, turning one or more portions of the media on or off such as blocking one or more portions of the media, controlling portions of the media that water can flow into, or a combination thereof.

The water curtain can be formed by providing water from a water supply source to a distribution manifold and allowing the water to fall by gravity back down into the supply source. The incoming air stream can be directed through the water curtain. Water is evaporated into the incoming air. The amount of water evaporated can be controlled by the water flow rate from the supply or by controlling the size or section of the water curtain.

The open water trough can be achieved by directing the incoming air to flow over standing water in a large open shallow tank. A water pump or water supply may be needed to keep water spread throughout in the tank.

Atomizing water into the incoming air by a spraying device can be preferred. The water can be introduced by spraying into the incoming air. In one example, water can be sprayed into a passage within an air duct where the incoming air is flowing through and mixed into the incoming air. One or more humidity measuring devices such as hygrometers can be used to monitor humidity levels. One or more water control devices, such as valves, pumps, pressure devices, or a combination thereof, can be used to control or modify the water introduction rate. Water can be sprayed into the incoming air with an angle perpendicular to the flow direction of the incoming air, against the incoming air, along with the incoming air, or a combination thereof.

The velocity of air is reflected in the air flow rate of the incoming air and, in most cases, can be a design constant for a specific spray booth. With a predetermined air flow rate for a spray booth, the velocity of air can be different at different portions or locations within the air flow system of that spray booth. For example, the velocity of air can be higher in the air ducts than in plenums and filter houses. Water can be introduced into the incoming air at a location that provides maximum air velocity. In one example, water can be introduced into the incoming air in one or more incoming air ducts of the spray booth.

The conditioned incoming air can be supplied into the spray booth. One or more controlling devices or filters can be installed to control air flow directions, air flow rates, cross sectional size or diameter of air flow passage, air flow velocity, or a combination thereof. One or more devices can be installed in the spray booth to monitor temperature, humidity level, air flow, air pressure, solvent level, or a combination thereof. In one example, the controlling devices can comprise one or more supply fans and supply fan controls, one or more exhaust fans and exhaust fan controls, one or more dampers and controllers, or a combination thereof.

The air temperature of the conditioned spray booth can be affected by energy (in terms of BTU's) required to evaporate the water that is introduced into the spray booth. This energy can come from the incoming air resulting in lowered temperature of the conditioned incoming air. The latent energy of vaporization is 1060 BTU/lb for water. In the example described above, at the water flow rate of 37.4 gallons of water per hour, about 311.5 lbs water per hour (37.4 gallons×8.33 lb/gallon) is introduced into the spray booth. The energy required to evaporate the water is thus 330,190 BTU/hour (311.5×1060) (5504 BTU/minute). At the volumetric air flow rate of 15,000 CFM (mass air flow rate of 1212 lb/min) and the BTUs of 5504 BTU/minute, each pound of air must give up 5504/1212=4.54 BTUs of energy. The specific energy for air is 0.240 BTU/lb/° F. That can lead to a temperature reduction of 19° F. (4.54/0.240). Thus, the conditioned incoming air temperature can be reduced to 81° F. when the incoming air is at 100° F. (a 19° F. temperature reduction).

The humidity level of the conditioned spray booth can be measured using one or more humidity measuring devices. It can also be calculated based on the target specific humidity. For example, water can be added to the incoming air to achieve a target specific humidity of 60 grains per pound of dry air. Using the psychrometric chart, with the temperature of the air at 81° F. and the specific humidity at 60 grains/lb air, the % Relative Humidity of the conditioned spray booth can be at about 37% RH.

The humidity level of the incoming air and the target range of humidity level of the spray booth can be relative humidity levels. The temperature and humidity level of the incoming air can be in a range of from 80° F. to 120° F. and in a range of from 1% relative humidity (RH) to 25% RH, respectively. The conditioned spray booth can have a temperature and a humidity level in a range of from 60° F. to 100° F. and in a range of from 30% RH to 60% RH, respectively. The humidity level can be preferred in a range of from 30% RH to 50% RH.

The coating composition can be applied by spraying. The coating composition can also be applied by rolling, brushing, dipping, blade drawdown, or any other coating techniques or methods known to those skilled in the art.

The waterborne coating composition can comprise one or more metallic effect pigments. Any of the aforementioned effect pigments, gonioapparent pigment, metallic flakes, or a combination thereof, can be suitable. The substrate can have a coating layer having an existing visual coating effect produced from one or more existing metallic effect pigments, and the coating layer produced thereof can have a visual effect matching the existing visual effect. The substrate can be a vehicle, vehicle body or a vehicle part.

The waterborne coating composition can comprise in a range of from 10% to 90% of water, percentage based on the total weight of the waterborne coating composition. The waterborne coating composition can also comprise one or more organic solvents, one or more inorganic solvents, or a mixture of organic and inorganic solvents.

In hot and dry climate, such as those locations or regions having temperature over 85° F. (about 30° C.) and with humidity levels less than 15% relative humidity (RH), wet coating layers produced from a waterborne coating composition can be dried too fast leading to undesired appearances, such as edge flashing, coarse dry, or other undesired appearance due to rapid water evaporation. For waterborne coating compositions that comprise effect pigments, such as metallic flakes, such un-desired appearance can significantly impact the visual appeal or quality of the coating. The edge flashing can occur when coating on a portion of a substrate panel starts to dry while the remaining portion of the same substrate panel is still being coated causing uneven appearance or edges. Coarse dry can make the coating appearing more coarse than desired and may require multiple coating overlays in order to produce a coating having desired appearance. The low humidity can also cause fast water evaporation from the droplets of the atomized waterborne coating composition during spray leading to insufficient amount of water in the coating composition when the droplets reach the substrate causing un-desired coating appearances.

Utilizing the process disclosed herein, the waterborne coatings can be applied in a dry and hot climate and the resulting coating layers can have acceptable appearances. The process of this disclosure can also help to reduce coating overlays (spray more coating compositions over a coating area to achieve a desired coating appearance), therefore reducing coating cost and materials usage. Such can be especially useful for coating compositions that comprise effect pigments, such as metallic flakes.

In addition, with the process disclosed herein, there is no need to have complicated humidity measuring and controlling devices and systems. The operator can determine water introduction rates based on local weather data that are readily available from local weather forecast or weather listing.

The process disclosed herein also provides that the amount of water introduced into the incoming air can be controlled and therefore prevents a user from introducing too much water into the incoming air than that can be evaporated.

This disclosure is also directed to a process for producing a predicted temperature and humidity level of a spray booth. The process can comprise the steps of:

1) obtaining a target water introduction rate, an air flow rate of an incoming air for the spray booth, a temperature and humidity level of the incoming air; and

2) producing the predicted temperature and humidity level of the spray booth based on the target water introduction rate, the air flow rate, and the temperature and humidity level of the incoming air.

The aforementioned water rate process can be suitable for determining the target water introduction rate.

Multiple values of predicted temperature and humidity levels can be produced at multiple target water introduction rates, multiple air flow rates of the incoming air, and multiple temperature and humidity levels of the incoming air to generate a humidity correlation function, as described above. The humidity correlation function can be suitable for predicting spray booth temperature and humidity levels at different conditions.

In one example, the process can be integrated into an Excel spreadsheet that can be executed on a computing device, and the water introduction rate can be determined based on the temperature and humidity level of the incoming air, the air flow rate of the incoming air, the target range of humidity level of the spray booth, and a humidity correlation function that correlates individual water introduction rates with temperatures and humidity levels of the incoming air, target ranges of the humidity levels of the spray booth, and air flow rates of the incoming air.

In another example, the process can be conducted in a computing device with at least one input device, such as keyboard, a digital reader, a touch screen, or a combination thereof, to enter or select input data. The computing device can have a display device to display the predicted temperature and humidity level based on the inputs. The computing device can further be coupled to one or more databases that can comprise the humidity correlation function. Any of the aforementioned computing devices can be suitable.

In yet another example, the process can be conducted as a chart system or a card system. The aforementioned input data and humidity correlation function can be arranged on the charts or cards.

This disclosure is further directed to a system for applying a waterborne coating composition over a substrate to form a coating layer. The system can comprise:

(A) a spray booth for spraying the waterborne coating composition over the substrate, the spray booth comprises one or more air inlets for introducing an incoming air into the spray booth;

(B) a water introduction device for introducing water into the incoming air; and

(C) a humidity correlation function that correlates individual water introduction rates with temperatures and humidity levels of the incoming air, target ranges of the humidity levels of the spray booth, and air flow rates of the incoming air;

wherein the water introduction device is configured to introduce water into the incoming air at a target water introduction rate determined based on temperature and humidity level of the incoming air, an air flow rate of the incoming air, a target range of humidity level of the spray booth, and the humidity correlation function.

The water introduction device can be turned on and off either automatically based on humidity levels of the incoming air, or manually by an operator.

The water introduction device can comprise one or more water spraying devices, one or more porous media, one or more water curtains, one or more open water troughs, or a combination thereof. The water introduction device can comprise one or more spray heads or nozzles. The water introduction device can comprise one or more pumps, regulators, water pressure measuring devices, valves, pipes, hoses, or a combination thereof.

The humidity correlation function can be obtained use any of the aforementioned methods. The humidity correlation function can be produced in the forms of charts, cards, wheel calculators, computer readable program products, or a combination thereof. In one example, the humidity correlation function is a set of printed charts. In another example the humidity correlation function is an Excel spreadsheet that can display the humidity correlation on a display device of a computing device.

In an exemplary embodiment, the system further includes one or more first thermal measurement devices for obtaining the temperature of the incoming air, one or more first humidity measuring devices for obtaining the humidity level of the incoming air, or a combination thereof. The system can further comprise one or more second thermal measurement devices for measuring temperature of air within the spray booth, one or more second humidity measuring devices for measuring humidity level of air within the spray booth, or a combination thereof. Typical temperature measuring devices and humidity measuring devices including any of the aforementioned devices can be suitable.

In another embodiment, the system contains a computing device functionally coupled to one or more devices selected from the first and the second humidity measuring devices, the water introduction device, or a combination thereof. The computing device can be functionally coupled to one or more of the aforementioned devices via wired or wireless connections. The computing device can be used to modify the water introduction rate based on the humidity level of the air within the spray booth, based on temperature and humidity level of the incoming air, or a combination thereof. The computing device can be used to modify the water introduction rate based on the humidity correlation function.

The computer can also record data related to temperature and humidity levels of the incoming air, the air flow rates of the incoming air, the humidity level and temperature of the air in the spray booth. The data can be stored in a data storage device, such as hard drive or a memory device of the computing device or an external data storage device, such as a hard drive or memory device that can be functionally coupled to the computing device.

The temperature and the humidity level of the incoming air can be obtained from a data provider, such as a local weather station, local weather forecast listing, newspaper, online weather date listing, or a combination thereof.

### EXAMPLES

The present disclosure is further defined in the following Examples. It should be understood that these Examples, while indicating embodiments of the disclosure, are given by way of illustration only. From the above discussion and these Examples, one skilled in the art can ascertain the essential characteristics of this disclosure, and without departing from the spirit and scope thereof, can make various changes and modifications of the disclosure to adapt it to various uses and conditions.

### Example 1

A humidity correlation function was established as follows: water was introduced into a duct for incoming air by spraying at the water introduction rate and air flow rate according to Table 1. Resulting temperatures and humidity levels of the spray booth are shown in Table 1 in pairs: Temperature/Humidity, at various ranges of temperature and humidity levels of incoming air (10% RH, 90-110° F.; 15% RH, 90-110° F.; and 20% RH, 90-110° F.).

Waterborne coating composition, Cromax® Pro, available from E.I. du Pont de Nemours and Company, Wilmington, Del., USA, was spray applied over a plurality of substrate panels at a plurality of humidity levels. Appearance of coating layers was assessed based on edge flashing, coarse dry, or a combination thereof. Humidity levels that resulted in no noticeable edge flashing or coarse dry were determined to be suitable humidity levels and indicated in foot note 1 of Table 1. When humidity was too low, some noticeable defects, such as edge flashing, coarse drying, or a combination thereof, were observed. When humidity was too high, drying time was prolonged.

TABLE 1
Humidity correlation table.

| Water | | | | | | | | | | |
|---|---|---|---|---|---|---|---|---|---|---|
| Rate | Air | | | | | | | | | |
| Gallons | Flow | | | | | | | | | |
| per | Rate | 10% RH | | | 15% RH | | | 20% RH | | |
| Hour | CFM | 90° F. | 100° F. | 110° F. | 90° F. | 100° F. | 110° F. | 90° F. | 100° F. | 110° F. |
| 20 | 10000 | 76/33¹ | 86/28² | 96/24² | 76/41¹ | 86/36¹ | 96/32¹ | 76/49¹ | 86/43¹ | 96/39¹ |
| | 12000 | 78/28² | 88/24² | 98/21² | 78/35¹ | 88/31¹ | 98/28² | 78/42¹ | 88/38¹ | 98/35¹ |
| | 14000 | 80/25² | 90/22² | 100/19² | 80/32¹ | 90/28² | 100/26² | 80/38¹ | 90/35¹ | 100/33¹ |
| 30 | 10000 | 69/53¹ | 79/43¹ | 89/36¹ | 69/63³ | 79/52¹ | 89/45¹ | 69/73³ | 79/62³ | 89/54¹ |
| | 12000 | 73/42¹ | 83/35¹ | 93/30¹ | 73/51¹ | 83/43¹ | 93/38¹ | 73/60³ | 83/52¹ | 93/46¹ |
| | 14000 | 75/36¹ | 85/30¹ | 95/26² | 75/44¹ | 85/38¹ | 95/33¹ | 75/52¹ | 85/46¹ | 95/41¹ |
| 40 | 10000 | 62/82³ | 72/64³ | 82/52¹ | 62/94³ | 72/76³ | 82/63³ | 62/100³ | 72/88³ | 82/75³ |
| | 12000 | 67/61³ | 77/49¹ | 87/41¹ | 67/72³ | 77/59¹ | 87/51¹ | 67/83³ | 77/70³ | 87/60³ |
| | 14000 | 70/50 | 80/41¹ | 90/34¹ | 70/59¹ | 80/50¹ | 90/43¹ | 70/69³ | 80/59¹ | 90/52¹ |

¹Relative humidity (% RH) was suitable.
²Relative humidity (% RH) was too low.
³Relative humidity was too high.

### Example 2

Predicted temperature and humidity level for a spray booth was produced according to an example of humidity calculator shown in Table 2. A target water introduction rate (gal/hr), air flow rate of an incoming air for the spray booth (CFM), temperature (° F.) and humidity level (% RH) of the incoming air were entered into an Excel spreadsheet as input data. A psychometric function according to Table 1 was integrated into the Excel to produce predicted temperature and humidity (Spray booth conditions, in Table 2).

TABLE 2
Humidity Calculator.

| Select incoming Air Conditions | Temperature ° F. | 100 |
|---|---|---|
| | % RH | 10% |
| Select Spray Booth Air Flow Rate (CFM) | | 12,000 |
| Choose a Water Introduction Rate (gal/hr) | | 30 |
| Resulting Air Temperature Reduction (° F.) | | 17 |
| Predicted Spray Booth Air Conditions | Temperature ° F. | 83 |
| | % RH | 35 |

### Example 3

A spray booth was installed with 24 water spray nozzles as the first set of water spray device, and 12 water spray nozzles as a second water spray device. Each of the nozzles has a water spray rating of 1.14 gallon/hr at 900 psi water pressure. The nozzles used in this example were NATURAL FOG® nozzle NFN Type BS, series #15, available from Multi-Tech Precision Industry Co., Ltd., Taichung City, Taiwan, under respective registered trademark. The historical humidity level of incoming air of about 10% RH and over 100° F., water introduction rate of 41 gallon/hr, air flow rate of 12,000 CFM, and target spray booth humidity level of over 36% RH were considered for determining the number of the water spray nozzles. Both sets of nozzles are connected to a water pump that is also controlled by a humidity control system CP-TSS available from Precision for Collision, Roseville, Calif.

At the beginning of a day in Sacramento, Calif., the incoming air didn't require conditioning: the relative humidity was above 38% RH, a preset upper shut off point, which as 2 percentage points above the target range of humidity level of 36% RH. The water pump was off and remained in the off state. As the temperature increased during the day, the humidity dropped below a turn-on set point (34% RH), which was 2 percentage points below the target range of humidity level of 36% RH. The controller turned on the water pump and the first set of the 24 nozzles introducing 27.4 gph (gallon per hour) of water into the incoming air. When the % RH in the spray booth increased up to the upper shut off point 38% RH, the pump was turned off. This on-off cycling of the pump continued as the outdoor temperature rose to maintain the RH level in the spray booth to be within the target range. In mid to late afternoon of the day, the outdoor temperature continued to rise and the % RH outside continued to drop until the water introduction rate from the first set of the nozzles was not enough to maintain the target range of %36 RH. When the % RH in the spray booth dropped to the preset first humidity level of 30% RH, the controller system opened the solenoid control valve that controls the 12 water spray nozzles of the second water spray device with a water introducing rate of 13.6 gph. The controller system cycled the solenoid valve open and closed between 30% RH and 34% RH during the hottest part of the day, maintaining the target range of the humidity in the spray booth all day long. The humidity variation with this humidity controller system was set to be about 2% RH.

The target humidity level of the air in the spray booth was set at 36% RH. The first preset humidity level was set at 32% RH (Table 3).

The system began operation when the system was powered under a predetermined configuration. In this example, the following configuration was set for the system:

when the humidity level of air in the spray booth dropped to 34% RH, the water pump was to be turned on automatically;
when the humidity level of air in the spray booth rose to 38% RH, the water pump was to turn off automatically;
when the humidity level of air in the spray booth dropped to 30% RH, the water pump was turned on automatically, and the dual set humidity valve (the solenoid control valve, in this example) was to be in the open state; and
when the humidity level of air in the spray booth rose to 34% RH, the water pump remained turned on, and the dual set humidity valve (the solenoid control valve, in this example) was to be in the closed state Additional configuration parameters are shown in Table 3.

TABLE 3
System Input and Setting.

| | |
|---|---|
| Spray Booth Air Flow Rate (CFM) | 12,000 |
| No. of 1^{st} Set of Nozzles | 24 |
| No. of 2^{nd} Set of Nozzles | 12 |
| Average Dew Point | 48° F. |
| Target Humidity Level (RH) | 36% |
| First Preset Humidity Level (RH) | 32% |
| Altitude (feet) | 370 |

The water pump and the dual set humidity valve were to be cycled on-and-off based on the humidity level according to the configuration above.

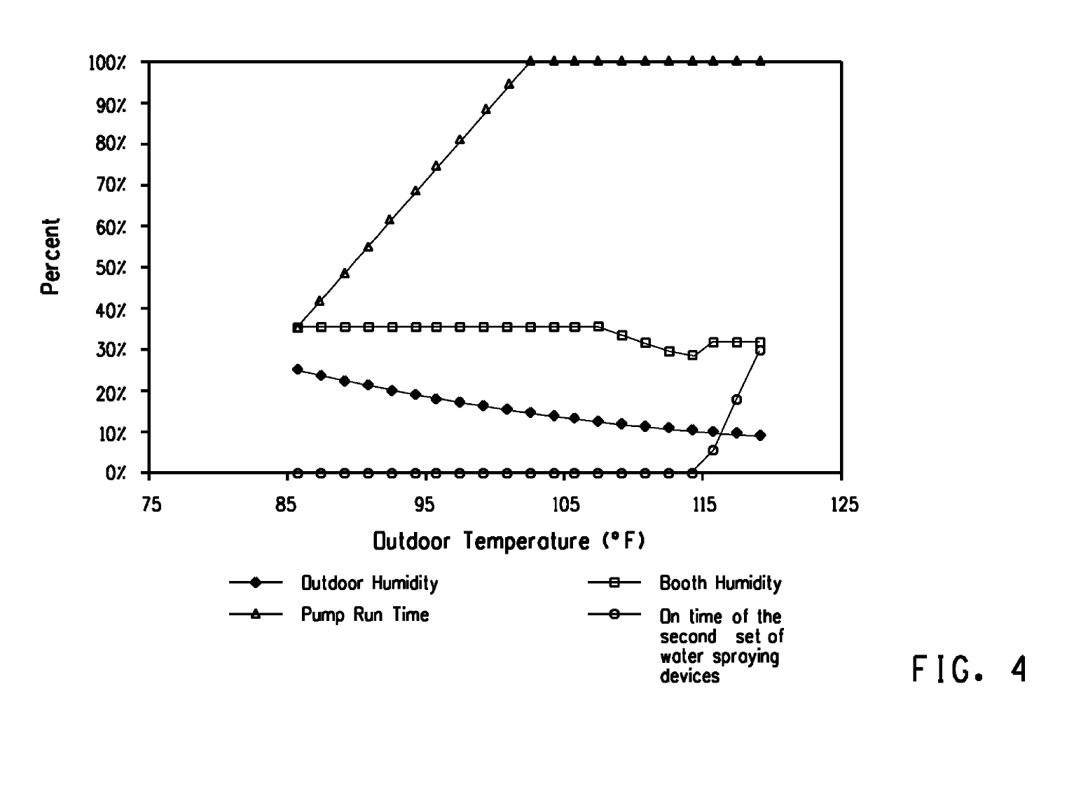

A profile of the spray booth is shown in FIG. 4. The system was powered in the morning when the outdoor temperature was about 30° C. (85° F.) with about 25% RH humidity. The water pump ran about 38% of time keeping the humidity in the spray booth at about 36% RH with the dual set humidity valve in closed state (Open circle). When outdoor temperature increased and outdoor humidity level (Solid diamond) decreased, the water pump run time increased (Open triangle) to 100% maintaining humidity level in the spray booth at about 36% (Open square). When the outdoor temperature continued to increase and the outdoor humidity level continued to decrease, the humidity level in the spray booth started to decrease even as the water pump ran at 100% of the time. When the spray booth humidity level decreased to about 30% to 34% RH (at about 46° C. or about 114° F.), the dual set humidity valve was cycled open and closed automatically. The dual set humidity valve and the water pump continued to run for the percentages of times shown in FIG. 4 to increase and maintain the humidity level in the spray booth at or close to the target humidity level.

1. A system for applying a waterborne coating composition over a substrate to form a coating layer, said system comprising:
a spray booth for spraying the waterborne coating composition over the substrate, wherein the spray booth comprises one or more air inlets for introducing an incoming air or conditioned incoming air into the spray booth; and
a water introduction device for introducing water into the incoming air, wherein the water introduction device comprises a first set of water spraying devices coupled to a first water supply device, a second set of water spraying devices coupled to a second water supply device, a water supply controlling device that controls water supply from the second water supply device to the second set of water spraying devices, and a water pump coupled to the first water supply device and the second water supply device;
a first humidity measuring device for measuring a humidity level of air within the spray booth;
wherein the water introduction device, when in operation, is configured to introduce water into the incoming air to produce the conditioned incoming air when the humidity level of air within the spray booth is below a target range of humidity level of the spray booth; and
wherein the water introduction device is configured to have the water supply controlling device in an closed state so water is only introduced from the first set of water spraying devices into the incoming air when the humidity level of air within the spray booth is below the target range of humidity level but is above a preset first humidity level, and wherein the water introduction device is configured to have the water supply controlling device in an open state so water is introduced from both the first and the second set of water spraying devices into the incoming air when the humidity level of air within the spray booth is below the preset first humidity level.

2. The system of claim 1 further comprising a first thermal measurement device for measuring temperature of air within the spray booth, a second thermal measurement device for measuring temperature of the incoming air, and a second humidity measuring device for measuring humidity level of the incoming air.

3. The system of claim 1, wherein the water pump and the water supply controlling device each is coupled with the first humidity measuring device to receive an actual humidity level of air within the spray booth, wherein, when in operation:
the water pump is configured to automatically provide water to the first water supply device and the second water supply device when the actual humidity level of air within the spray booth is below the target range of humidity level,
the water supply controlling device is configured to automatically be in the closed state turning off the water supply to the second set of water spraying devices when the actual humidity level of air within the spray booth is below the target range of humidity level but is above the preset first humidity level, and
the water supply controlling device is configured to automatically be in the open state to supply water to the second set of water spraying devices via the second water supply device when the actual humidity level of air within the spray booth is below the preset first humidity level.

4. The system of claim 1 further comprising a computing device functionally coupled to the first humidity measuring device, the water supply controlling device, and the water pump;
wherein the computing device is configured to comprise a first set point when the humidity level of air within the spray booth is below the target range of humidity level but is above the preset first humidity level, and a second set point when the humidity level of air within the spray booth is below the preset first humidity level; and
at the first set point, when in operation, the computing device automatically causes the water supply controlling device to be in the closed state and causes the water pump to supply water only to the first set of water spraying devices via the first water supply device; and
at the second set point, when in operation, the computing device automatically causes the water supply controlling device to be in the open state and causes the water pump to supply water to both the first set of water spraying devices and the second set of water spraying devices via the first water supply device and the second water supply device.

5. The system of claim 4, wherein the computing device is functionally coupled to the first humidity measuring device, the water supply controlling device and the water pump via wired or wireless connections.

6. The system of claim 4, wherein the computing device comprises a display device to display the target range of humidity level, the preset first humidity level, an actual humidity level of air within the spray booth, the closed state or the open state of the water supply controlling device, operation of the water pump, or a combination thereof.

7. The system of claim 1, wherein the first set of water spraying devices and the second set of water spraying devices are housed in an air duct device coupled to the one or more air inlets.

8. The system of claim 1, further comprising a subsequent set of water spraying devices coupled to an individual subsequent water supply device that each is coupled to a subsequent individual water supply controlling device and the water pump.

9. The system of claim 1, wherein a number of the first set of water spraying devices and a number of the second set of water spraying devices are determined based on parameters comprising individual water spray rates of the water spraying devices, temperature and humidity level of the incoming air, target ranges of humidity levels of the spray booth, and air flow rates of the incoming air.

10. The system of claim 9, wherein the parameters further comprise a history of temperatures and humidity levels of the incoming air.

11. The system of claim 1, wherein temperature level of the incoming air is in a range of from about 26° C. to about 48.9° C. and humidity level of the incoming air is in a range of from about 1% relative humidity to about 25% RH, and wherein the spray booth, when in operation, has an actual air temperature and an actual humidity level of air within the spray booth of from about 15.56° C. to about 37.8° C. and of from about 30% RH to about 60% RH, respectively.

12. The system of claim 1, wherein the incoming air, when in operation, is flowing into the spray booth at an air flow rate that is essentially constant.

13. A substrate coated with a coating layer produced in a system for applying a waterborne coating composition over the substrate to form the coating layer, wherein the coating layer is essentially free from edge flashing or coarse dry, and wherein the system comprises:
a spray booth for spraying the waterborne coating composition over the substrate, wherein the spray booth comprises one or more air inlets for introducing an incoming air or conditioned incoming air into the spray booth;
a water introduction device for introducing water into the incoming air, wherein the water introduction device comprises a first set of water spraying devices coupled to a first water supply device, a second set of water spraying devices coupled to a second water supply device, a water supply controlling device that controls water supply from the second water supply device to the second set of water spraying devices, and a water pump coupled to the first water supply device and the second water supply device;
a first humidity measuring device for measuring a humidity level of air within the spray booth;
wherein the water introduction device, when in operation, is configured to introduce water into the incoming air to produce the conditioned incoming air when the humidity level of air within the spray booth is below a target range of humidity level of the spray booth; and
wherein the water introduction device is configured to have the water supply controlling device in an closed state so water is only introduced from the first set of water spraying devices into the incoming air when the humidity level of air within the spray booth is below the target range of humidity level but is above a preset first humidity level, and wherein the water introduction device is configured to have the water supply controlling device in an open state so water is introduced from both the first and the second set of water spraying devices into the incoming air when the humidity level of air within the spray booth is below the preset first humidity level.

14. The substrate of claim 13, wherein the waterborne coating composition comprises one or more metallic effect pigments, wherein the substrate has one or more existing coating layers having an existing visual coating effect produced from one or more existing metallic effect pigments, and the coating layer produced thereof having a visual effect matching an existing visual effect.

15. The substrate of claim 14, wherein the substrate is a vehicle, vehicle body, or a vehicle part.
